(19) United States
(12) Patent Application Publication
(10) Pub. No.: US 2021/0059454 A1
(43) Pub. Date: Mar. 4, 2021

(54) SELF-LEARNING, AUTOLOCKING SECURE MAILBOX SYSTEM

(71) Applicant: Oladayo Luke, Severn, MD (US)

(72) Inventor: Oladayo Luke, Severn, MD (US)

(21) Appl. No.: 16/554,851

(22) Filed: Aug. 29, 2019

(51) Int. Cl. A47G 29/12; G07C 9/00

(52) U.S. Cl. CPC A47G 29/1214; A47G 2029/1226; G07C 9/00309; G07C 9/00166

(57) ABSTRACT

The present invention is related to a self-learning autolocking secure mailbox system. The self-learning autolocking secure mailbox system comprises of an automatic unique size detachable auto lock system (not limited to locking direction), emote operated key pad, WIFI adaptor to enable remote control, device app (IOS and android) to control lock, mail picking assistance app. The mailbox is further attached with mounted open and close drive shafts for auto lock mechanism, remote open a losing system with event alert, alarm for force opening, on demand pickup request when mail is full, voice control system to check for new mail, internal and external camera, image recognition to detect the mail in the box and additionally enables users to create code for third parties to open box at lock time. Furthermore, the present invention provides routine learning (owner specified routine or learn routine for mailman delivery routine and owner mail pickup routine) and intelligent monitoring, so that the owner can track and receive the mail in a secure manner.

### CROSS-REFERENCE TO RELATED APPLICATIONS

No related applications are previously filed.

### Field of the Invention

The present invention relates to a mailbox. More particularly to a self-learning mailbox having an automatic opening/closing or autolocking door system with enabled alarm operated by mobile application for securing received mail.

### BACKGROUND OF THE INVENTION

Traditional mailbox is well known in the art, typically comprises a receptacle made of metal or any other material with conventional locking mechanism where the postman drops regular mails posts. When you live in a multistoried apartment, you know that the mailbox area features number of boxes next to each other with the apartment's number and sometimes is accessible to other people when you forgot to lock the mailbox. Moreover, the receiver/owner won't know accurately when a mail is arrived, there's a possibility they might miss important mails. It is also highly possible for other people to get access to your private mails.

Further, to identify if any mail is arrived, it is frequently required to reach and check manually into the mailbox. Similar issue with the mechanical lock mailbox system, the loss of keys or losing the lock combination often requires replacing the lock, which results in unnecessary expenditures and waste of time. Also, the security of the mailbox becomes again a matter of concern when the mailbox has a number lock, and tenants or the owners of the house change because the old residents will now have access to the new residents' mail. These and many other problems have been long identified. Different solutions to the problems have been tried. However there exists no comprehensive solution to all the above problems.

Therefore, the object of the invention overcomes above and other drawbacks from the prior art.

To achieve above and other objects, the present invention provides a smart/advanced mailbox system that not only receive the mail but also has options for advance autolocking system, enabled cameras, and mobile operated application (App) with self-learning/routine learning capabilities.

In the present invention, mailbox attached with mounted open and close drive shafts for auto lock mechanism with device application to control lock (when installed, it will open and close box door)

Another object is, device application-based control lock has capability to automatically open, during mail delivery time periods. Moreover, it will automatically learn mailman delivery routine as well as learn mailbox owner mail pickup routine.

The present invention offers a new system where the mailbox is integrated with mobile application or mail piking assistance application upon the arrival of your mail, it win send you a notification or text message of the mail to your cell phone, in this way you know exactly when your mail arrives. Moreover, on demand pickup request when mail is full.

A further object of the invention is to provide, image recognition algorithm to detected if mail in the box. More specifically, interior camera that can take pictures of the content and send notification. Additionally, exterior camera will send the notification and image of the people who is opening the box.

One another object of the invention is providing owner to use fingerprint to login into the application/Touch ID. To retrieve your mail, you need a password, it's a better security to keep other people from accessing your private information, reducing the risk of identity theft. Yet another object present invention is to provide alarm mode setting for forced opening of mailbox.

Yet another object is, ability to create code for third party to open box at lock time.

Yet another object is, the lock will remain unlock when postman is in front of it or when battery is below 5% and until it is replaced.

Relevant Patents

| Patent No. | Title of Invention |
|---|---|
| CA2932874A1 | Smart mailbox, smart mailbox system and |
| | related methods |
| U.S. Pat. No. 9,322,194B2 | Intelligent door lock system |
| U.S. Pat. No. 8,947,530B1 | Smart lock systems and methods |
| U.S. Pat. No. 6,987,452B2 | iBOX with home delivery auto-receipt |
| | system |
| U.S. Pat. No. 9,683,391B2 | Intelligent door lock system including |
| | intelligent security system with reduced |
| | latency |

### SUMMARY OF THE INVENTION

There is a need of more intelligent self-learning mailbox to modernize delivery operations and to provide more security. The advanced mailbox can overcome many shortcomings of the traditional mailbox. Present invention is a combination of camera, a keypad, a keylock, mounted open and close drive shafts imbedded into a mailbox that can be operated through a mobile application remotely and alarm. The enabled alarm is to identify and notify if any unauthorized access to the mailbox has been occurred. In addition, the camera will record all accesses to the mailbox, send notifications to the mobile application, and mail pickup service man according to the user settings. Furthermore, this present invention provides routine learning (owner specified routine or learn routine for mailman delivery routine and owner mail pickup routine) and intelligent monitoring, so that the owner can track and receive the mail in a secure manner.

### BRIEF DESCRIPTION OF THE SEVERAL VIEWS OF THE DRAWINGS

Following drawings with reference numbers and exemplary embodiments are referenced for explanation purpose.

FIG. 1 illustrates the front view of the mailbox showing keypad, lock an camera.

FIG. 2 illustrates the front view of the mailbox with the door opened showing the “back part” which includes Inside camera and motor enabled auto lock system.

FIG. 3 illustrates the different views of mailbox. FIG. 3A shows the front view of mailbox displaying the keypad and lock system. FIG. 3B shows the left side view of mailbox displaying the keypad, lock system and back part. FIG. 3C shows the top plane view of the mailbox displaying the keypad, lock system and back part. FIG. 3D shows the internal view of the mailbox display the lock system and back part. FIG. 3D (i) shows the explosive view of different parts of the back part.

FIG. 4 illustrates the transparent view displaying the interior of the mailbox and the motor enabled to lock system.

FIG. 5 illustrates the settings of the programmable mobile application/computing unit.

FIG. 6 illustrates the logical workflow of the operation of the lock mechanism of the intelligent mailbox system.

FIG. 7 illustrates the logical workflow of the operation of the motor enabled auto close mechanism of the intelligent mailbox system.

### DETAILED DESCRIPTION OF THE INVENTION

The present invention provided a self-learning, autolocking secure mailbox system which including a box body having a door with a lock; a box opening keypad device for inputting box opening code so as to lock the box and thus unlock it; external/internal cameras and a communication unit for communicating with a computing unit such as mobile or smart watch or computer/laptop or tablet.

The fundamental part of this invention is the self-learning or routine learning, autolocking multifeatured mailbox, which utilizes several existing technologies, such external and internal cameras, the WIFI/internet adaptor to enable remote control, the device application (IOS or Android) to control lock.

The present invention respectively includes the following one or more optional features: The mailbox further includes mounted open and close drive shafts for auto lock mechanism, utility lock that is not limited by locking direction.

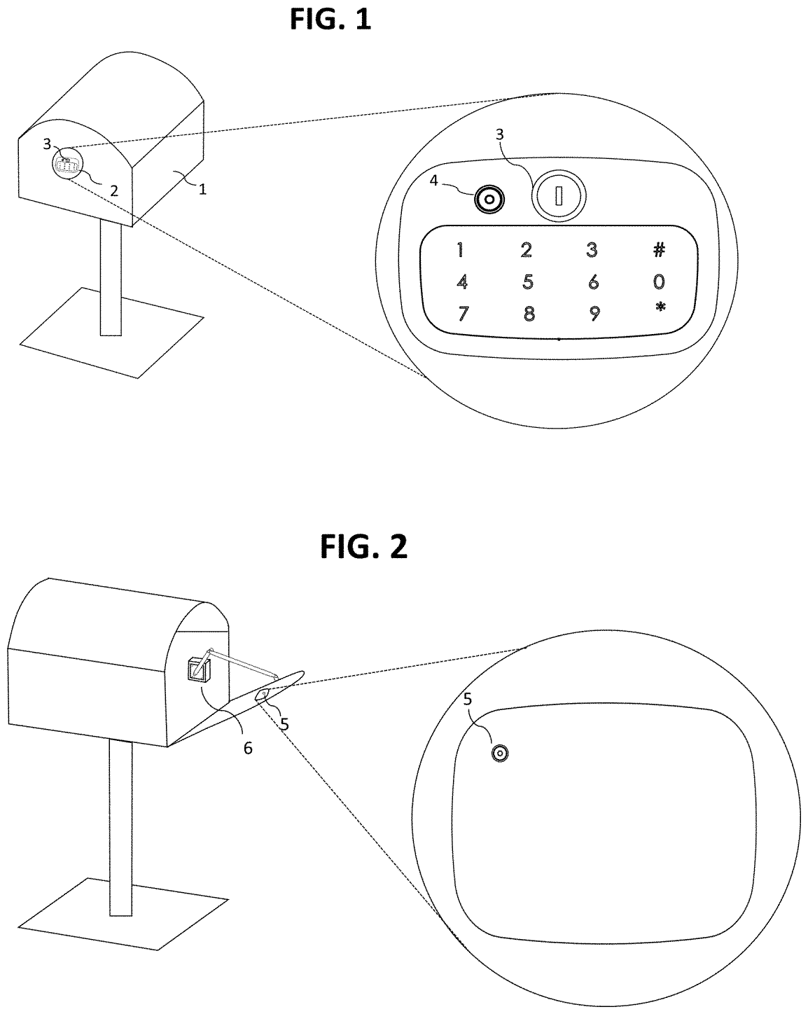

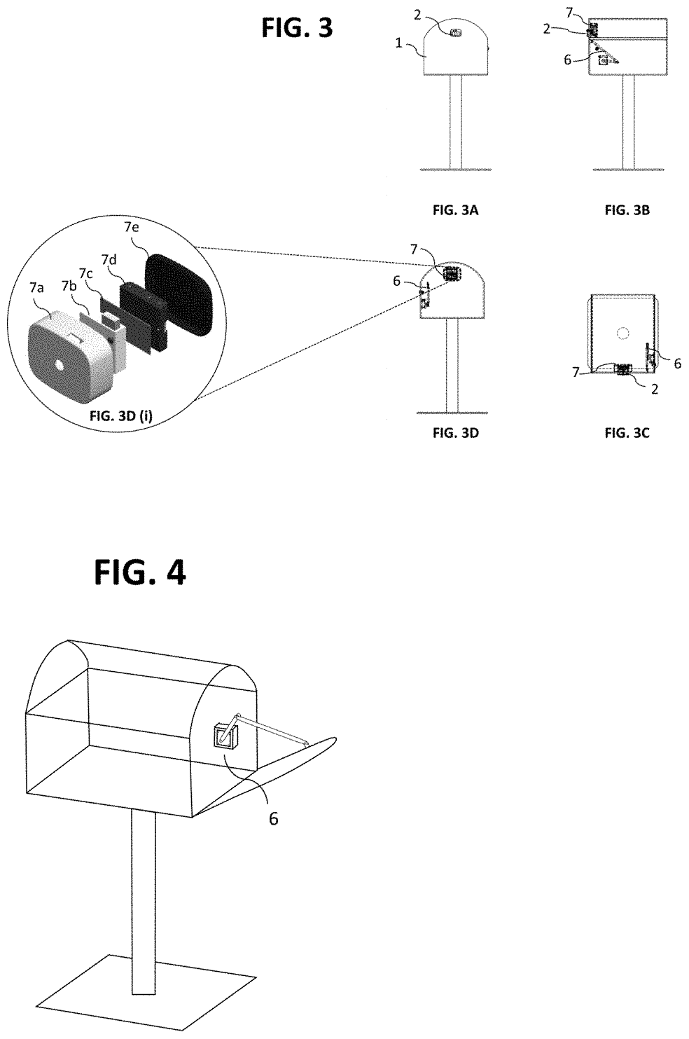

In present invention FIG. 1 illustrate an example of the basic mailbox design which includes Front view of the mailbox 1, showing a keypad 2, a lock 3 and external camera 4. Similarly FIG. 2 visualizes the open-door view of the mailbox showing the internal Camera 5 and motor enabled auto lock system 6, Back part 7, which further contains a case (7a), lock mechanism (7b), PCB (7c), Batteries (7d) and cover (7e).

In one embodiment, the uniquely designed lock 3, is associated with lock case (7a), locking mechanism (7b), PCB (7c), batteries (7d), and cover (7e).

In one embodiment, the uniquely designed lock 3, can be easily be installed on any mailbox. The lock 3 typically require electricity from attached batteries (74). When the batteries (7d) run out of power, the lock 3 will remain unlock. Similarly, when battery is below 5% and until it is replaced, the lock 3 will remain unlock.

In present invention, lock 3 can be configured to use software to perform several tasks associated with data communication and/or locking the door. The lock 3 can wirelessly communicate with a remote computing device. In some embodiments the lock 3 communicates with a remote computing device such as mobile phone/smart watch/computer/laptop/tablet.

In one embodiment, on the front door of mailbox 1, which includes a programmable keypad 2, is a generic code input device. The keypad 2 can be part of the mailbox lock system.

The system comprises a keypad 2 associated with a mailbox 1 lock in a door, where the keypad 2 comprises keypad buttons, and the keypad 2 has configured to receive an access code from a user.

In one embodiment the user, can operate the keypad 2 via its mobile device, or other web-enabled device.

Once the user enters an access code which is communicated to the door lock control system 7b through the communication network to unlock the door.

In one embodiment, mailbox 1 consist of at least one external camera 4, includes at least one front camera 4 for monitoring the situation around the mailbox 1 before the opening; that detects who is opening the mailbox 1 and sent the notification to the remote management terminal via the communication unit. The outside camera 4 is situated in the front side of the mailbox 1.

The mailbox 1 further includes at least one internal camera 5, that can take pictures of the content and send notification. Additionally, the internal camera 5 will detect when mailbox is empty or contain mails and send the notification to the remote management terminal via the communication unit.

In one embodiment, mailbox 1 the further includes an alarm device, for alarming at force opening situation; and the alarm information is also sent to the remote management terminal via the communication unit.

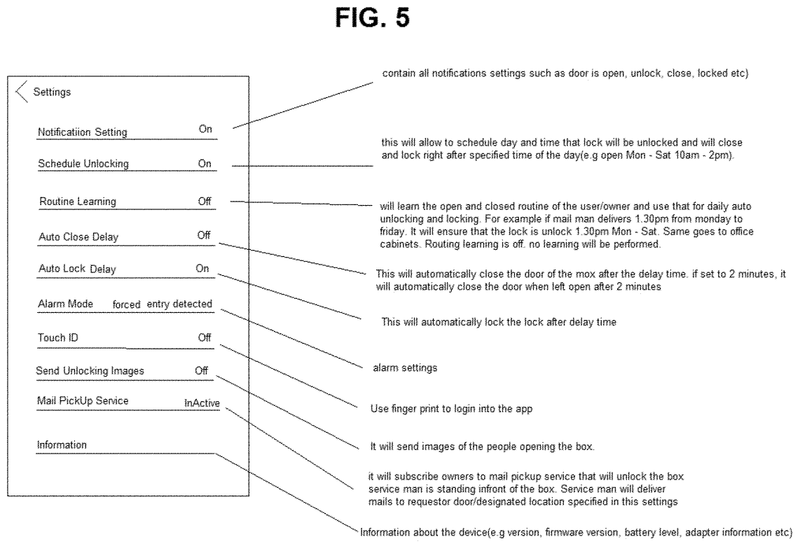

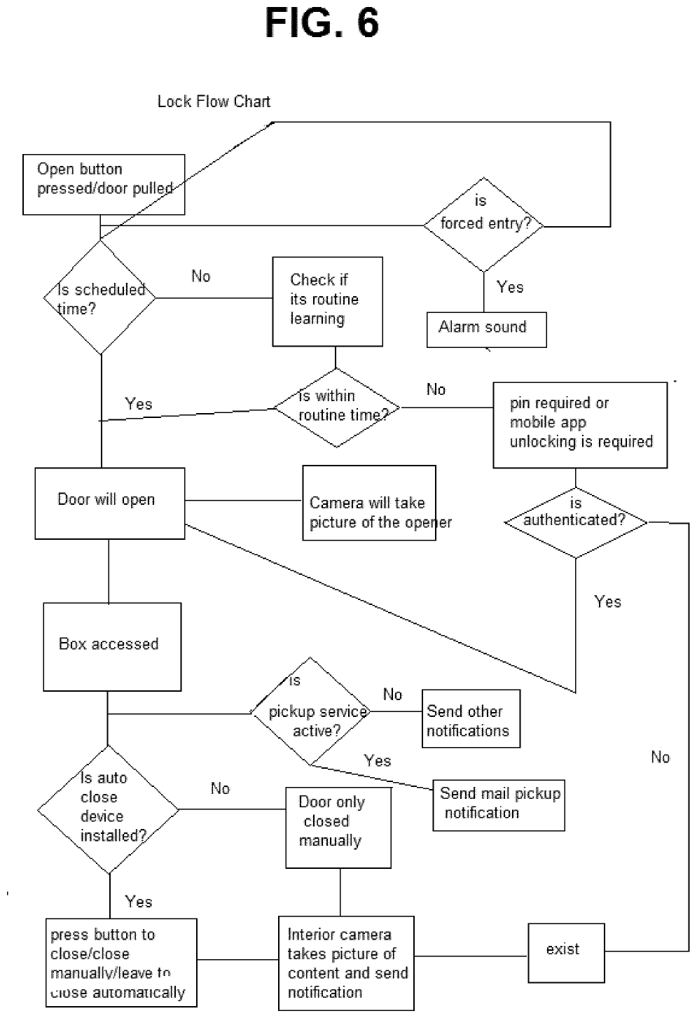

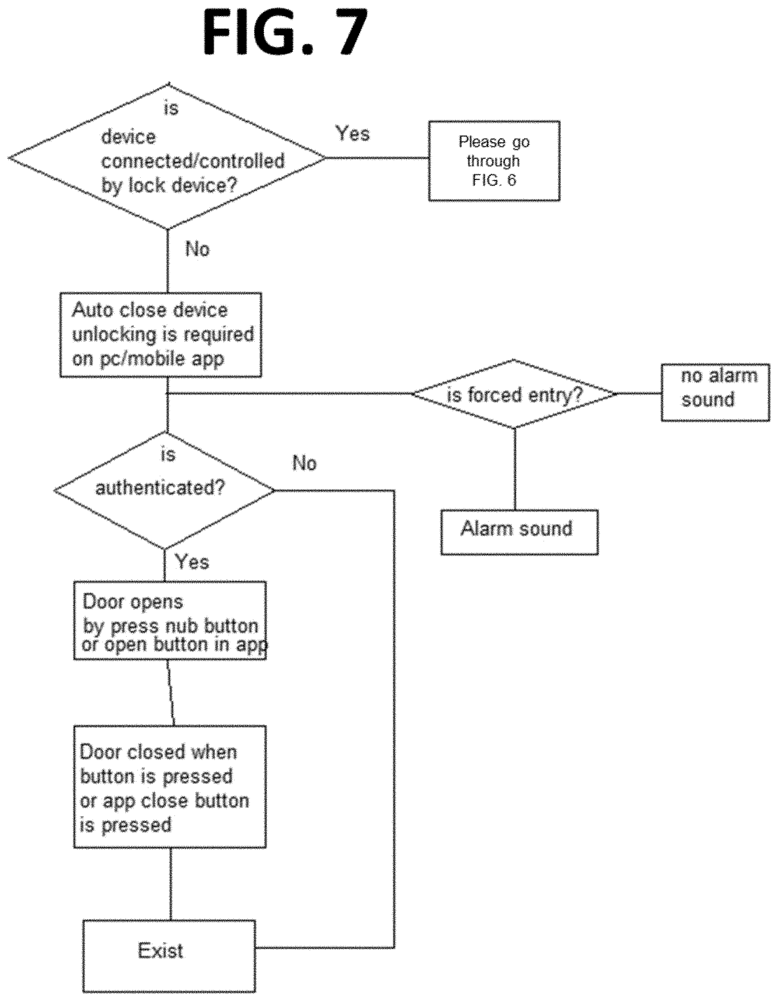

In one embodiment, the communication unit could use the common mobile communication network (such as networks of 2G/3G/4G/5G), or wireless communication network like WIFI. In one embodiment, in FIG. 5 describes the mobile application settings which includes notification setting, schedule unlocking, routine learning, auto close delay, auto lock delay, alarm mode, touch ID, send unlocking image, information.

The mobile application settings FIG. 5 describe notification settings that contain all notification settings such as open/close or lock/unlock. For example, the owner of the mailbox 1 can receive the wireless notification in every situation such as open close or lock/unlock of the mailbox door.

Further, the mobile application settings FIG. 5 describes schedule unlocking means in the present invention. It also presents the mail pickup service subscription and request to deliver mail to designated location in the house. It will also allow to schedule day and time that lock will be unlocked and will close and lock right after specified time of the day (e.g. open Mon-sat 10 am to 11 am)

Further, the mobile application settings FIG. 5 describes one more setting that is routine learning or self-learning. In this setting, the mailbox 1 will learn the open and closed routine of the user owner and use that for daily auto unlocking. For example, if mailman delivers 10:30 am from Monday to Friday, it will ensure that the lock is unlock 10:30 am Monday to Saturday.

Another mobile application settings FIG. 5 option describe auto close delay setting. In this setting, the mailbox 1 will automatically close the door after the delay time. If the time is set to 2 minutes, the mailbox 1 will automatically close the door when left open after 2 minutes.

Further mobile application settings FIG. 5 describes auto lock delay this will automatically lock the lock after delay time.

Further mobile application settings FIG. 5 describes an alarm Mode that will work when forced entry detected.

Another mobile application settings FIG. 5 describes touch ID that will use fingerprint to login into the app or application.

Further mobile application setting FIG. 5 describes, sending unlocking images. In this setting option, it will send images of the people who is trying to be opening the mailbox 1.

The Information setting option describe the Information about the device (e.g. Version, firmware version battery level, adaptor information).

FIG. d depicts a flow diagram embodiment that showing methods of operating a mailbox system by auto close device.

In this flow diagram first will describe auto close device flow chart in which if mailbox system is connected/controlled auto close device. Then auto/close device unlocking is required on PC/Mobile application or app. If it is authenticated entry the door opens by the press nub button or open button in mobile application. After that door closed when button is pressed, or app close button is pressed.

In other condition, if it is not an authenticated entry or it is forced entry the alarm sound will come, and door will not open by the press nub button.

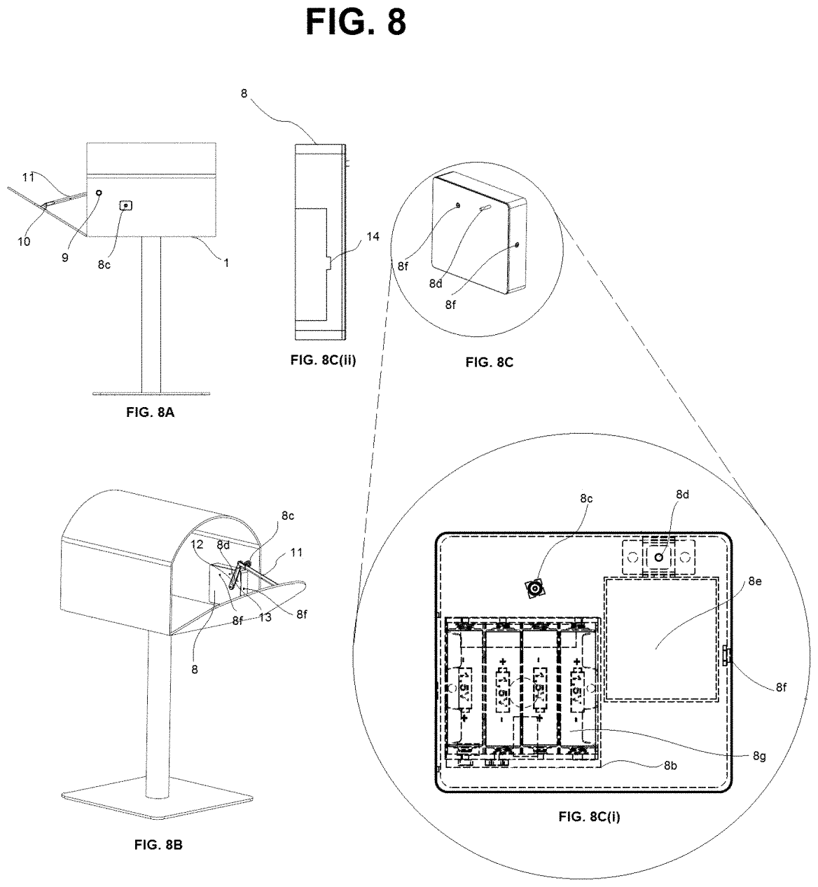

FIG. 7 illustrates a flow diagram embodiment that showing methods of operating a mailbox system by lock.

In this flow diagram if the mailbox system not connected by the lock device then if open button pressed/door pulled by forced entry then alarm sound will come, and door will not open. If it is an authentic entry in fixed schedule time, then door will open.

There is a certain condition where, if the entry is in between the schedule time or it is a routine learning door will open.

In another condition if it is not in routine learning and schedule time then pin/code or mobile app unlocking required for opening the mailbox door if it is authenticated entry door will open, if not door will not open and camera will take the picture of the mailbox opener.

The box will be accessed, if auto close device not installed door only closed by manually. Afterward interior camera takes picture of the content and send the notification.

I/We claim:

1. A self-learning auto-locking secure mailbox system comprising:
a mailbox at least having one door wherein mailbox system comprising
a unique lock;
a programmable keypad;
external-internal Cameras;
alarm;
WIFI adaptor to enable remote control;
a device app (IOS and android) to control lock; and
mailbox attached with mounted open and close drive shafts for auto lock mechanism.

2. The self-learning auto-locking mailbox system claimed as claim 1, wherein lock system connects with keypad, lock mechanism, secure casing and computing unit.

3. The self-learning auto-locking secure mailbox system claimed as claim 1, wherein lock connects to auto close device to provide mailbox to auto closing door.

4. The self-learning auto-locking secure mailbox system claimed as claim 1, wherein auto lock includes fixed hinge, rod 1, rod 2, push button, on/off switch, motor, motor case.

5. The self-learning auto-locking secure mailbox system claimed as claim 1, wherein auto lock/auto close system can be operated by computing system if auto close app installed in the mobile application setting.

6. The self-learning auto-locking secure mailbox system claimed as claim 1, wherein lock enables mobile application which provide routine learning or self-learning setting, in this setting it will learn the open and closed routine of the user/owner and use that for daily auto unlocking. For example, if mailman delivers 10:30 am from Monday to Friday, it will ensure that the lock is unlock 10:30 am Monday to Saturday.

7. The self-learning auto-locking secure mailbox system claimed as claim 1, wherein lock that is not limited by locking direction.

8. The self-learning auto-locking secure mailbox system claimed as claim 1, wherein keypad that is remote abed keypad or controlled by mobile application setting.

9. The self-learning auto-locking secure mailbox system claimed as claim 1, wherein external camera to detect who is opening the door and internal camera that detects who is opening box and detects when box is empty or contain mail(s); it will use image recognition algorithm to detect if mail(s) in the box. It will have capability to send notifications (like when box is opened/closed, when mails are picked, when mails are not yet picked, when mail man deliver mails.

10. The self-learning auto-locking secure mailbox system claimed as claim 1, wherein alarm is for farce opening. The alarm setting also provided in the mobile application setting.

11. The self-framing auto-locking secure mailbox system claimed as claim 1, wherein ability to send notification to on-demand mail pickup service man when this function is activated by user in the settings. The mail pickup service setting also provided in the mobile application setting.
